(19) United States
(12) Patent Application Publication
(10) Pub. No.: US 2016/0134741 A1
(43) Pub. Date: May 12, 2016

(54) USER-DIRECTED INFORMATION CONTENT

(71) Applicant: Vinc Corporation, San Diego, CA (US)

(72) Inventors: Gordon Scott SCHOLLER, Providence, RI (US); Ronen Zeev LEVY, Corona, CA (US); Zahi Itzhak SHIRIZLI, La Jolla, CA (US)

(73) Assignee: VINC CORPORATION, San Diego, CA (US)

(21) Appl. No.: 14/934,635

(22) Filed: Nov. 6, 2015

Related U.S. Application Data
(60) Provisional application No. 62/076,399, filed on Nov. 6, 2014.
(60) Provisional application No. 62/076,414, filed on Nov. 6, 2014.

(51) Int. Cl. H04M 1/725

(52) U.S. Cl. CPC H04M 1/72527

(57) ABSTRACT

A content-presenting apparatus may include an output device configured to output to a user content of a content unit in a form sensible to a user. A storage device may store a collection of interrelated content units having a sequence link to at least one other content unit. A plurality of the content units may have sequence links to at least three other content units. A sequence link may be to a content unit that does not have a sequence link back to the same content unit. A processor may be configured to output on the at least one output device content units sequentially in response to inputs received from the user on at least one input device, receive on the at least one input device an indication input by the user that correlates to a sequence link back to a content unit not having a reciprocal sequence link.

### RELATED APPLICATIONS

This application claims the benefit of U.S. Provisional Application No. 62/076,399, filed Nov. 6, 2014, and U.S. Provisional Application No. 62/076,414, filed Nov. 6, 2014, which applications are incorporated herein by reference in their entirety for all purposes.

This application is related to an application filed by the same applicant on the same day, Nov. 6, 2015, as this application is being filed, and having the title GUIDANCE CONTENT DEVELOPMENT AND PRESENTATION, which application is incorporated herein in its entirety for all purposes.

### FIELD

This disclosure relates to information content navigation. More specifically, the disclosed embodiments relate to systems and methods for user-directed navigating through information content in a presentation.

### BACKGROUND

A learner may require guidance in learning a process, procedure, or topic. For example, a student may require guidance in learning scholastic topics. As another example, a user of an unfamiliar product may need guidance on proper assembly, installation, or use of such product. Typically, guidance is delivered via media information appropriately selected, segmented, configured, sequenced and/or presented by an expert. An expert can deliver guidance to a learner via personal tutoring and/or prerecorded instructions, for example. Prerecorded instructions and information presentations are statically presented without awareness of a particular learner's understanding.

### SUMMARY

Apparatus and methods may provide user-driven information-content presentations. In some embodiments, a user-driven content-presenting apparatus may include at least one output device, a storage device, at least one input device, and a processor. The at least one output device may be configured to output to a user content of a content unit in a form sensible to a user. The storage device may store a collection of interrelated content units. Each content unit may having a sequence link to at least one other content unit. A plurality of the content units in the collection of interrelated content units may have sequence links to at least three other content units. At least one sequence link of at least one of the content units in the plurality of content units may be a sequence link to a content unit that does not have a sequence link back to the at least one content unit. The at least one input device may receive inputs from the user. The processor may be configured to output on the at least one output device content units sequentially in response to inputs received from the user on the at least one input device. The processor may be configured to receive on the at least one input device an indication input by the user that correlates to a respective one of the sequence links with another content unit, such as a sequence link to a content unit that does not have a sequence link back to the at least one content unit.

Features, functions, and advantages may be achieved independently in various embodiments or may be combined in yet other embodiments, further details of which can be seen with reference to the following description and drawings.

### BRIEF DESCRIPTION OF THE DRAWINGS

FIG. 1a is an illustration of the display of a first example of a content unit in the form of a scene.

FIG. 1b is an illustration of a first example of accessing a next-sequential scene.

FIG. 1c is an illustration of a second example of accessing a next-sequential control unit in the form of a scene response.

FIG. 1d is an illustration of the display of a second example of a scene indicating associated scene responses.

FIG. 1e is an illustration of the display of a list of scene responses displayed in response to a user input.

FIG. 1f is an illustration of the display of an example of accessing scene responses.

FIG. 1g is an illustration of the display of accessing a content unit in the form of a response scene accessed from a response.

FIG. 2 is an example of a user-navigation map illustrating representative sequence links between content units.

FIG. 3 is an illustration of the display of a third example of a content unit in the form of a scene.

FIG. 4 shows examples of exemplary display pages showing illustrative content units in the form of scenes and scene responses of a content collection forming an exemplary user guide.

FIG. 5 is a schematic diagram of an exemplary data processing system that may be configured as a content-presenting apparatus.

FIG. 6 is a schematic representation of an illustrative computer network system that also may be configured as a content-presenting apparatus.

### DESCRIPTION

A learner-centered guidance system may effectively guide a learner without need of an actual expert being physically present. For example, a learner-centered guidance system may present information to a user while accepting input commands, allowing learner feedback to be generated. Such learner feedback may enable a guidance system to present information tailored to a learner's needs, somewhat emulating or otherwise mimicking personal tutoring. Furthermore, a learner-centered guidance system may have internet connectivity, enabling a richer experience.

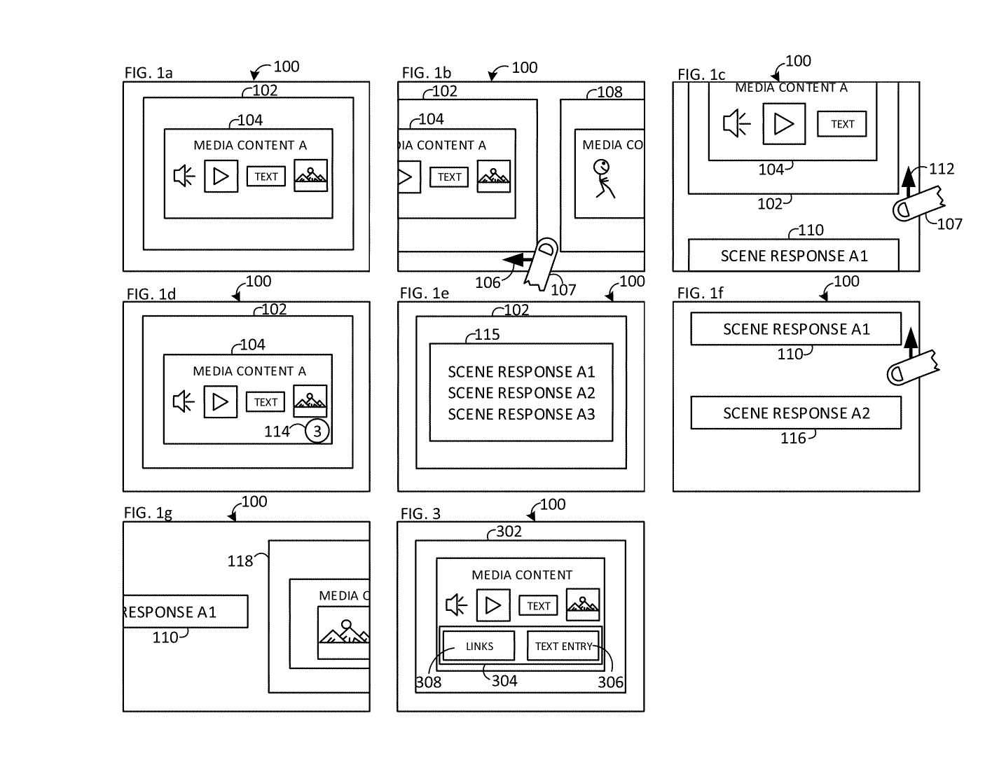

Embodiments are disclosed herein that relate to a system for displaying or otherwise presenting learner-centered information in a sensible form. FIG. 1a shows a display, generally indicated at 100, displaying a scene 102 of a collection of user guidance content units, also referred to as an information plan, produced by a presentation module of a guidance system. The display in this example is an output device in displaying the selected content units, as well as an input device using the touch-sensitive responsiveness of the display. A collection of content units may be an information plan that presents steps or procedures for completing one or more tasks. A content unit, such as scene 102, may be in the form of a displayed page that may present to a user information using one medium or more than one medium, referred to generally as media content, such as audio, video, text, and/or images. Content units may or may not be displayed, depending on the media and output devices being used

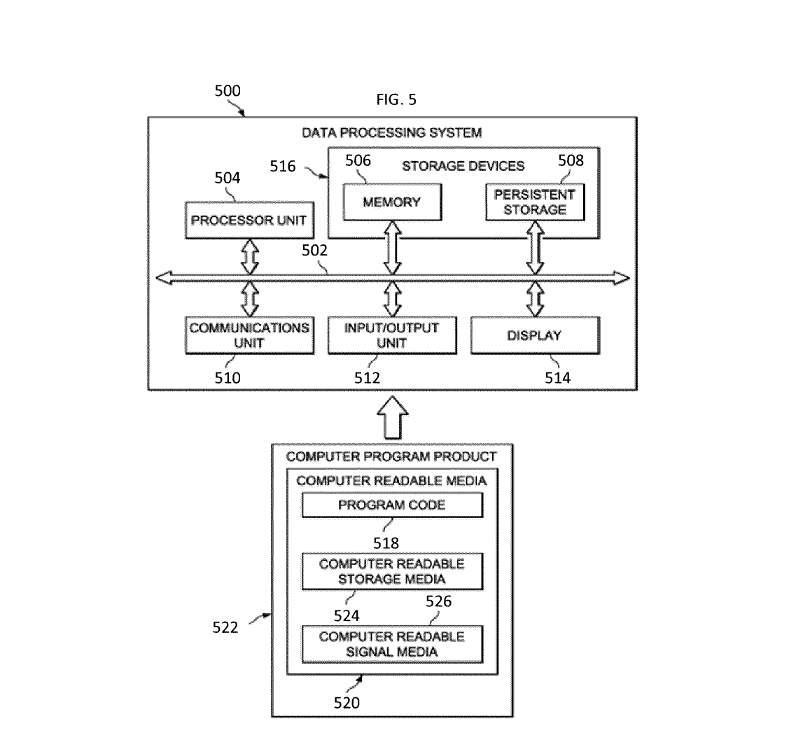

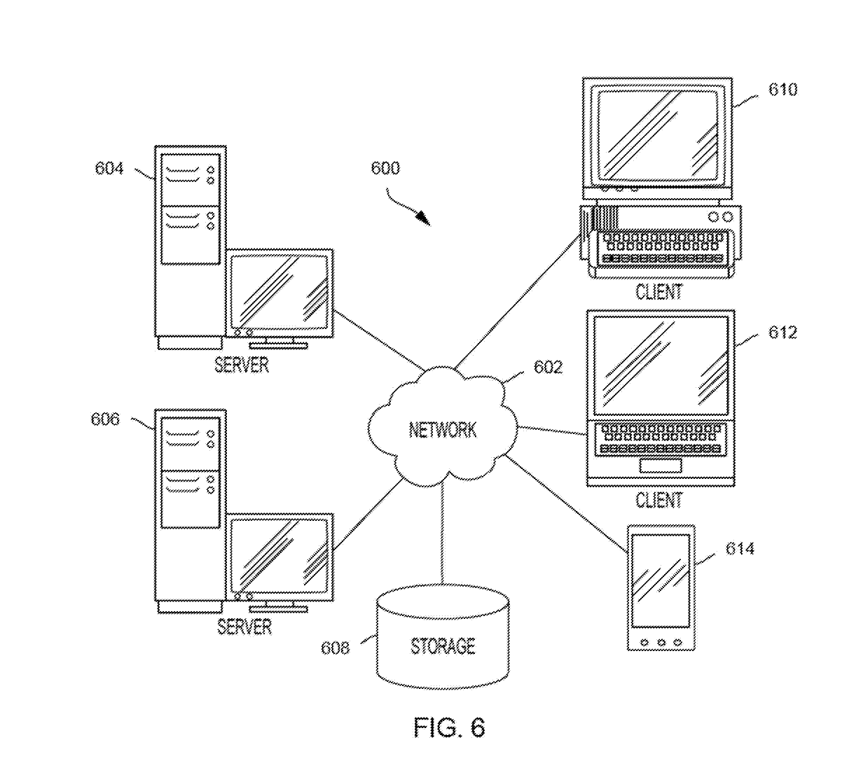

In this figure, the media content is “media content A” identified with reference number 104. Scene 102 may be one of a plurality of scenes displayable serially as a sequence by the guidance system. The guidance system may be operational on a device having a processor and memory that is capable of presenting information to a user via display 100. For example, scene 102 may be presented via a touch screen, a display screen with a keyboard, or cursor controller, such as a mouse, for entering controls. Display 100 may be a display of a tablet, mobile smart phone, video game system, desktop computer, work station, or other personal or network-based computer. Scene 102 may be presented via a local or otherwise partially or completely network-based application. For example, an appropriate computing system and a network are shown in FIGS. 5 and 6, respectively.

Media content 104 may provide to a user information about a subject. For example, media content 104 may be directed to guiding a user on proper assembly, installation, or use of a product, such as changing a mobile phone battery, installing a wireless network or speaker system, or assembling a storage shed. As another example, media content 104 may be directed to guiding a user in learning a scholastic topic. Media content 104 may also include a single medium for presentation or may involve interactive or selectively actuatable media, such as interactive buttons, text entry fields, or selectable links for activating different media. A scene may include more than one occurrence of a given type of media, each with different content or a different form of the same content, or similar content may be provided by each of different types of media.

A user may navigate between guidance content units, such as scenes, responses, choices, and other forms of information displays provided by the guidance system via a user input. FIG. 1b illustrates a user input 106 in the form of a finger 107 moving across a touch-screen display, causing the guidance system to transition from displaying scene 102 to displaying an adjacent scene 108. Scene 108 may be sequentially next after scene 102 in a series of scenes. Particularly, FIG. 1b shows a user inputting input 106 for navigating between scene 102 and scene 108 by executing a right to left (i.e. leftward) swipe of finger 107 on a touch screen display 100, resulting in the display of scene 108.

At any point, a user may navigate back to scene 102 by swiping an opposite direction (i.e. rightward) (not shown). A user input that allows navigation to adjacent scenes may work in any direction provided by the guidance system. For example, displaying scene 108 may be accomplished by swiping rightward instead of leftward. In any case, displaying scenes in opposite directions may require directionally opposite user inputs. Although FIG. 1b shows user input as a swiping gesture via a user's finger(s), user input may be administered in any suitable way, such as via clicking and/or dragging a mouse pointer, expressing voice commands, selecting a display transition with an electronic stylus, or entering a command using a keyboard. Scene 108 and any other scene displayable by the guidance system may include any feature or features that may be used to provide information or navigate from a scene to another document, examples of many of which are described in the present disclosure.

In the following description, for simplicity, navigation is generally indicated by a swiping action of a user's finger, it being understood that any other suitable navigation technique may also be used. The guidance system may allow a user to navigate between adjacent scenes in a directionally intuitive way. Further, a user may provide inputs to the guidance system using techniques provided by mobile smart phones or touch screen displays. For example, zooming in or out may be accomplished via a user pinching or otherwise spreading their fingers. As another example, pausing a streaming video may be accomplished via a user tapping a touch screen display. It is to be understood that other suitable techniques may be used to control or select the playing of a recorded media segment.

The guidance system may display a scene response in response to a user input for an associated scene. A response is associated with a particular scene and may be a document that provides further detail on or elaboration of information provided in the associated scene. A scene may have no responses, one response, or a series of responses associated with it. A response, in turn, may have no response scene, one response scene, or a series of response scenes associated with and accessed from the associated response.

For example, FIG. 1c illustrates the display of a scene response A1 110 in response to a user input 112. User input 112 may be directionally perpendicular or otherwise transverse to user input 106 of FIG. 1b. In particular, user input 112 may be administered by swiping from down to up (i.e. upward) while viewing scene 102. Scene response A1 110 may be one of a plurality of scene responses related to and providing further detail or information that will assist a user in understanding the content A in scene 102. Alternatively, a scene may have related only one scene response or even no scene responses. After receiving content A in scene 102, a user needing further information regarding the scene content may provide a user input such as user input 112 that requests that a scene response be displayed, and the scene response will provide further information about the scene. A user may continue swiping in a same direction, causing the guidance system to display one or more scene responses related to the associated scene.

Alternatively, the guidance system may include a virtual interactive button that displays a number of scene responses related to a particular scene. An example of such an interactive button is shown in FIG. 1d as scene response button 114, indicating a number of scene responses available. Particularly, as a nonlimiting example, FIG. 1d shows scene response button 114 indicating that three scene responses are available. A user may activate or select such an interactive button via a user input, resulting in the display of one or more scene responses in a list, such as scene response list 115 shown in FIG. 1e. Once displayed, the one or more scene responses may be selectable via an additional user input. Selection of a scene response by a cursor control device or screen touch causes the selected scene to be displayed. It is to be understood that interactive button 114 may take any suitable form selectable to provide a user with access to response list 120 and/or other indication of available scene responses. Alternatively, interactive button 114 may instead merely indicate a number of scene responses related to a particular scene without being interactive or selectable.

FIG. 1f illustrates a user swiping upward while viewing scene response A1 110 of FIG. 1c, resulting in the guidance system displaying scene response A2 116. The content or subject matter of scene response A2 may supplement or complement the content of scene response A1, both of which provide further information about the scene content A with which they are associated. A user may also swipe in an opposite direction to display a previous scene response. For example, with respect to FIG. 1f, a user may swipe downward while viewing scene response A2 116 to navigate to or display scene response A1 110. Scene responses may include any one or more types of media, including but not limited to text, images, animations, or videos. It is to be understood that displaying a scene response may be accomplished via any appropriate user input.

FIG. 1g shows a user navigating to a scene 118 from scene response A1 110. Navigating to an adjacent scene of a response may be accomplished similarly as described above with respect to FIG. 1b (e.g., swiping, clicking, dragging). An adjacent scene to a response may or may not be related to the response. Where scene response A1 110 provides an introduction to additional information on subject matter in scene A 102, scene 118 may include content that provides additional information on the subject matter provided in scene response A1 110. Scene 118 may be the only scene associated with scene response A1 110, or it may be the first of a series of scenes associated with scene response A1 110.

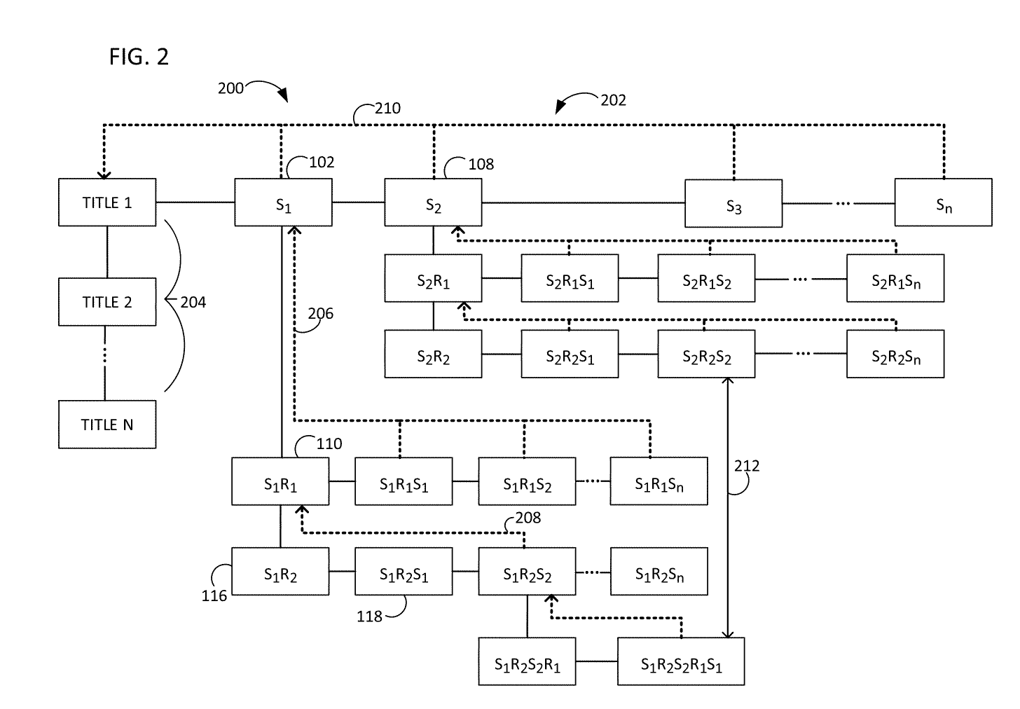

As such, FIGS. 1a-g show how a user may navigate through displayed media content unit by at any point administering a user input causing the guidance system to display an adjacent scene or scene response. FIG. 2 shows a user navigation map 200 of representative user guidance content unit collection 202, such as a user guide, illustrating different paths that may be traversed selectively by a user between display pages displaying content units in the user guidance content unit collection. General scenes presentable by the guidance system are notated in FIG. 2 as “S₁,” “S₂,” “S₃,” . . . “Sₙ”, where n is a number of sequential scenes. In some examples, each scene in a series of scenes may provide progressive information on the general subject matter of the series of scenes as indicated by a base display page, such as a title page or a response. Each scene in a series of scenes may also provide information not included in other scenes of the same series. Responses presentable by the guidance system are notated in FIG. 2 as “SₙR₁,” “SₙR₂,” “SₙR₃,” . . . “SₙRᵢ”, where i is a number of sequential responses associated with scene Sₙ. Possible paths a user may navigate are illustrated in FIG. 2 by lines between display pages. In reference to FIGS. 1a-g, corresponding scenes 102, 108 and 118, and scene responses 110 and 116 of FIGS. 1a-g are shown in FIG. 2. Solid lines indicate a navigation path that a user may choose to navigate between adjacent display pages, such as between scenes and/or responses. Also shown in FIG. 2 are title pages 204, which are main root scenes providing information about the user guidance content associated with each title page. A collection of user guidance content units may exist for each title page.

For example, a selected collection of user guidance content units may be a user guide generally directed to information about a particular product, such as a mobile phone user guide for a particular manufacturer. As such, title pages 204 may each indicate different models offered by a particular manufacturer, and a user may choose between titles by swiping upwardly or downwardly as described previously for displaying responses associated with a scene. A user may select a title by swiping to bring the desired title into view, then display an adjacent scene of the associated collection of user guidance content units, by swiping leftward as illustrated above in FIG. 1b. It is to be understood that title pages 204 may or may not be accessible while a user is viewing subsequent scenes or responses related to such title page. In some examples, a downward swipe on a base scene, such as “S₁,” “S₂,” “S₃,” or “Sₙ,” will return the user to the associated title page. It is to be understood that any number of titles 204 may be presentable by the guidance system. For example, FIG. 2 shows “Title N,” where N is any appropriate number.

A collection of user guidance content units, such as a user guide, may be developed by a development person or team so that the content of a given display page may have content determined by the position in the collection of user guidance content units and the type of display page it is. Generally, a scene provides new information on a subject matter identified by a base display page, such as a title page or a response. As has been mentioned, a series of scenes sequentially displayable provide a general level of information on the subject matter identified by the base display page. Additionally, each response of a series of responses associated with a scene provides new, more-detailed information about a base scene from which the responses depend.

The level of detail of a given response or scene thus depends on how many levels from a base scene it is. For example, the scene in collection 202 of user guidance content units identified as S₁R₂S₂R₁S₁ provides information about the subject of response S₁R₂S₂R₁. Response S₁R₂S₂R₁ in turn provides further detail for information provided in scene S₁R₂S₂. Scene S₁R₂S₂ provides additional information on the subject matter provided in response S₁R₂. As has been discussed, response S₁R₂ provides further detail on information provided in scene S₁.

There are several aspects to discontinuous movements (“jumps”) within an app. They can be based on user preferences. For example based on the users preferences that assistance app jumps to providing configuration assistance for a product that is specific to the users preferences including all media that is presented. Jumps can be based on a programmatic assessment of inputs. For example, a tech might be asked to input the temperature, pressure and input voltage to a piece of equipment. Based on that information, the assistance app would sequentially jump to the most probable problems and solutions. If the first one doesn't fix the problem, it jumps to the second one and so on. Jumps can be based on a combination of user preferences and a programmatic assessment of inputs.

FIG. 2 indicates exemplary root return routes in dashed lines. For simplicity, only a few of a total number of root return paths are shown in FIG. 2. It is to be understood that the examples shown may apply to any of the scenes in the collection of user guidance content units.

After a user navigates through a certain path, the user may want to return to a base scene or previous response that was part of the path to the current display page. For example, if a user is at S₁R₁S₁, the user may want to return to base scene S₁. A user may do so by swiping downward, for example, thereby returning the display to base scene S₁, as shown by line 206. Alternatively, swiping downward may return a user to a previous response instead of a base scene. For example, a user at S₁R₂S₂ may desire to return to previous response S₁R₁. Swiping downwardly may return her or him to response S₁R₁, as shown by line 208. Similarly, swiping downwardly on a scene may return the user to the initial display page, such as a response or title page, for a series of scenes that the current scene is part of. For example, swiping downwardly while on scene S₃ returns the user to the title page for the collection of user guidance content units, as illustrated by line 210.

FIG. 3 shows a scene 302 on display 100 including interactive multimedia 304. Interactive multimedia 304 may include a text entry field 306 and links 308. Text entry field 306 may allow a user to input text data which the guidance system may use to determine a subsequent display page to display. For example, text entry field 306 may be a form that a user may fill out for the purpose of commenting on the content included in the collection of user guidance content units. Text entry field 306 may be used to input user data that is stored in an associated storage device, either locally or remotely via a network.

Although FIG. 3 shows only one text entry field, one or more text entry fields may be provided, and the fields may allow input of a suitable amount of text. In some examples, a drop-down menu may provide a list of allowable entries from which a user selects an applicable one, which is then automatically entered in the field. Further, one or more text entry fields may be displayed in response to a user having viewed a series of scenes or responses related to a particular scene. For example, a user may be prompted to enter comments about a set of responses after the user has viewed a set of responses or series of scenes associated with a response.

The guidance system may be configured to prompt a user to provide input using any appropriate form of media, including but not limited to text entry fields, selectable entries in a list of entries, or voice response to an audio prompt. Links 308 of FIG. 3 may enable a user to navigate to non-adjacent scenes not accessible by swiping. For example, links 308 may allow a user to skip certain scenes that a user does not want to view. As such, turning back to FIG. 2, a user may navigate to any scene presented by the guidance system. For example, a user may navigate from S₁R₂S₂R₁S₁ to S₂R₂S₂, as shown by arrow 212. Links 308 thus may move the user to any other display page in given collection of user guidance content units, depending on how the guidance system is configured. Several links may be provided in any scene, giving the user options or choices as to which display page of the collection of user guidance content units is next displayed.

As described above, a user of guidance system may navigate between adjacent or non-adjacent scenes, sequentially view responses related to scenes, and interact with interactive media. User input data may be processed by the disclosed guidance system to receive feedback on the content of the collection of user guidance content units or to determine a path through the collection of user guidance content units. Further, in some examples, the guidance system may record usage data and store such data locally or to a network database. Such usage data may be used by experts to understand and/or enrich user experience of guidance system 100. For example, usage data may include time a user spends on particular scenes or responses. As another example, usage data may include user input patterns and/or text entry field data as described above.

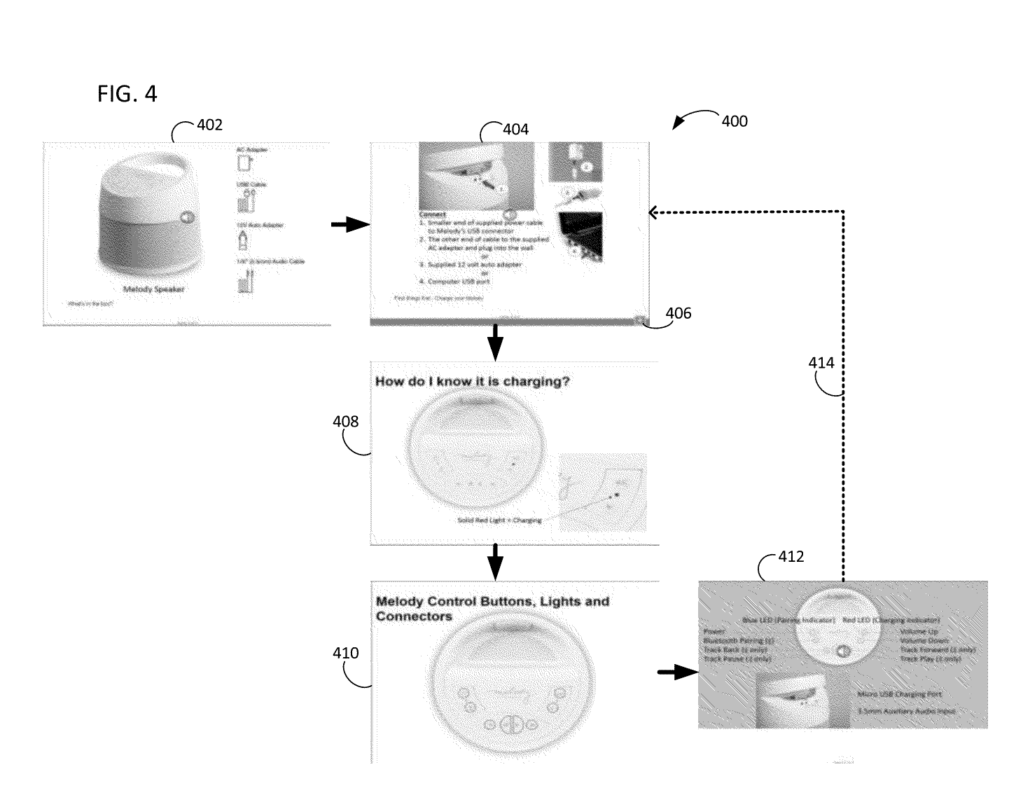

FIG. 4 shows examples of display pages of an exemplary collection of content units in the form of a user guide 400. Particularly, user guide 400 includes media content related to informing a user on the proper use of a speaker product. In more detail, FIG. 4 shows an initial, base scene 402 showing various components of a speaker unit to a user. In response to a user input, such as swiping to the left, the display changes to display adjacent scene 404. Scene 404 provides additional detail on the various speaker components. For example, scene 404 shows instructions on charging a battery contained in the speaker unit.

Media content of scene 404 also includes an interactive scene response button 406 as described above in FIG. 1d, indicating that four responses are available that provide further details on the information presented in scene 404. In response to the user swiping upwardly, the display displays a response 408. Response 408 provides further information to a user who may be having difficulty following the instructions provided by scene 404. Particularly, response 408 describes how a user might know if the speaker is properly charging. As such, a user having difficulty understanding scene 404 may easily access help or guidance by administering a user input causing response 408 to be displayed. Similarly, a further response 410 may also be displayed in response to an additional user navigational input. In this example, response 410 elaborates on various control buttons, lights and connectors of the speaker product, further educating the user. Next, in response to a user navigational input, a scene 412 is displayed that adds additional detail to the information provided in response 410. When a user is ready to return to base scene 404, the user may input a user navigational input or command to do so. Returning to a base scene 404 is represented by dashed line 414.

In summary, the guidance system may provide collection of user guidance content units that presents media to a user on different series of display pages in a learner-centered fashion. In this way, content may be selected by a user according to user inputs or user feedback, emulating or otherwise mimicking personal tutoring.

FIG. 5 illustrates a data processing system 500 that may be configured as a user-driven content-presenting apparatus. In this example, data processing system 500 is an illustrative data processing system for implementing a system for displaying learner-centered media content as discussed above with reference to FIGS. 1a-4.

In this illustrative example, data processing system 500 includes communications framework 502. Communications framework 502 provides communications between processor unit 504, memory 506, persistent storage 508, communications unit 510, input/output (I/O) unit 512, and display 514. Memory 506, persistent storage 508, communications unit 510, input/output (I/O) unit 512, and display 514 are examples of resources accessible by processor unit 504 via communications framework 502. It is to be understood that display 100 described above may be an example of display 514 in this illustrative example. Further, any input device described above may be an example of an input/output (I/O) unit 512.

Processor unit 504 serves to run instructions for software that may be loaded into memory 506. Processor unit 504 may be a number of processors, a multi-processor core, or some other type of processor, depending on the particular implementation. Further, processor unit 504 may be implemented using a number of heterogeneous processor systems in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device is any piece of hardware that is capable of storing information, such as, for example, without limitation, data, program code in functional form, and other suitable information either on a temporary basis or a permanent basis.

Storage devices 516 also may be referred to as computer readable storage devices in these examples. Memory 506, in these examples, may be, for example, a random access memory or any other suitable volatile or non-volatile storage device. Persistent storage 508 may take various forms, depending on the particular implementation.

For example, persistent storage 508 may contain one or more components or devices. For example, persistent storage 508 may be a hard drive, a flash memory, a rewritable optical disk, a rewritable magnetic tape, or some combination of the above. The media used by persistent storage 508 also may be removable. For example, a removable hard drive may be used for persistent storage 508.

Communications unit 510, in these examples, provides for communications with other data processing systems or devices. In these examples, communications unit 510 is a network interface card. Communications unit 510 may provide communications through the use of either or both physical and wireless communications links.

Input/output (I/O) unit 512 allows for input and output of data with other devices that may be connected to data processing system 500. For example, input/output (I/O) unit 512 may provide a connection for user input through a keyboard, a mouse, and/or some other suitable input device. Further, input/output (I/O) unit 512 may send output to a printer. Display 514 provides a mechanism to display information to a user. Input and output devices may be combined, as is the case for a touch-screen display.

Instructions for the operating system, applications, and/or programs may be located in storage devices 516, which are in communication with processor unit 504 through communications framework 502. In these illustrative examples, the instructions are in a functional form on persistent storage 508. These instructions may be loaded into memory 506 for execution by processor unit 504. The processes of the different embodiments may be performed by processor unit 504 using computer-implemented instructions, which may be located in a memory, such as memory 506.

These instructions are referred to as program instructions, program code, computer usable program code, or computer readable program code that may be read and executed by a processor in processor unit 504. The program code in the different embodiments may be embodied on different physical or computer readable storage media, such as memory 506 or persistent storage 508.

Program code 518 may also be located in a functional form on computer readable media 520 that is selectively removable and may be loaded onto or transferred to data processing system 500 for execution by processor unit 504. Program code 518 and computer readable media 520 form computer program product 522 in these examples. In one example, computer readable media 520 may be computer readable storage media 524 or computer readable signal media 526. It is to be understood that the guidance system discussed above may include program code stored on a storage device 516 or be included on computer program product 522, program code 518, computer readable media 524, or computer readable signal media 720.

Computer readable storage media 524 may include, for example, an optical or magnetic disk that is inserted or placed into a drive or other device that is part of persistent storage 508 for transfer onto a storage device, such as a hard drive, that is part of persistent storage 508. Computer readable storage media 524 also may take the form of a persistent storage, such as a hard drive, a thumb drive, or a flash memory, that is connected to data processing system 500. In some instances, computer readable storage media 524 may not be removable from data processing system 500.

In these examples, computer readable storage media 524 is a physical or tangible storage device used to store program code 518 rather than a medium that propagates or transmits program code 518. Computer readable storage media 524 is also referred to as a computer readable tangible storage device or a computer readable physical storage device. In other words, computer readable storage media 524 is a media that can be touched by a person.

Alternatively, program code 518 may be transferred to data processing system 500 using computer readable signal media 526. Computer readable signal media 526 may be, for example, a propagated data signal containing program code 518. For example, computer readable signal media 526 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 518 may be downloaded over a network to persistent storage 508 from another device or data processing system through computer readable signal media 526 for use within data processing system 500. For instance, program code stored in a computer readable storage medium in a server data processing system may be downloaded over a network from the server to data processing system 500. The data processing system providing program code 518 may be a server computer, a client computer, or some other device capable of storing and transmitting program code 518.

The different components illustrated for data processing system 500 are not meant to provide architectural limitations to the manner in which different embodiments may be implemented. The different illustrative embodiments may be implemented in a data processing system including components in addition to and/or in place of those illustrated for data processing system 500. Other components shown in FIG. 5 can be varied from the illustrative examples shown. The different embodiments may be implemented using any hardware device or system capable of running program code. As one example, data processing system 500 may include organic components integrated with inorganic components and/or may be comprised entirely of organic components excluding a human being. For example, a storage device may be comprised of an organic semiconductor.

In another illustrative example, processor unit 504 may take the form of a hardware unit that has circuits that are manufactured or configured for a particular use. This type of hardware may perform operations without needing program code to be loaded into a memory from a storage device to be configured to perform the operations.

For example, when processor unit 504 takes the form of a hardware unit, processor unit 504 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 518 may be omitted, because the processes for the different embodiments are implemented in a hardware unit.

In still another illustrative example, processor unit 504 may be implemented using a combination of processors found in computers and hardware units. Processor unit 504 may have a number of hardware units and a number of processors that are configured to run program code 518. With this depicted example, some of the processes may be implemented in the number of hardware units, while other processes may be implemented in the number of processors.

In another example, a bus system may be used to implement communications framework 502 and may be comprised of one or more buses, such as a system bus or an input/output bus. Of course, the bus system may be implemented using any suitable type of architecture that provides for a transfer of data between different components or devices attached to the bus system.

Additionally, communications unit 510 may include a number of devices that transmit data, receive data, or both transmit and receive data. Communications unit 510 may be, for example, a modem or a network adapter, two network adapters, or some combination thereof. Further, a memory may be, for example, memory 506, or a cache, such as that found in an interface and memory controller hub that may be present in communications framework 502.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

FIG. 6 describes a network data processing system 600 in which illustrative embodiments of user-driven content-presenting apparatus may be implemented. It should be appreciated that FIG. 6 is provided as an illustration of one implementation and is not intended to imply any limitation with regard to environments in which different embodiments may be implemented. Many modifications to the depicted environment may be made.

Network data processing system 600 is a network of computers in which one or more illustrative embodiments of a system for displaying learner-centered media content may be implemented. Network data processing system 600 may include network 602, which is a medium configured to provide communications links between various devices and computers connected together within network data processing system 600. Network 602 may include connections such as wired or wireless communication links, fiber optic cables, and/or any other suitable medium for transmitting and/or communicating data between network devices, or any combination thereof.

In the depicted example, a first network device 604 and a second network device 606 connect to network 602, as does a electronic storage device 608. In the depicted example, devices 604 and 606 are shown as server computers. However, network devices may include, without limitation, one or more routers, switches, voice gates, servers, electronic storage devices, imaging devices, and/or other networked-enabled tools that may perform a mechanical or other function. These network devices may be interconnected through wired, wireless, optical, and other appropriate communication links.

In addition, client electronic devices 610, 612, and 614 connect to network 602. Client electronic devices 610, 612, and 614 may include, for example, one or more personal computers, network computers, and/or mobile computing devices such as personal digital assistants (PDAs), smart phones, handheld gaming devices, wearable devices, and/or tablet computers, and the like. In the depicted example, server 604 provides information, such as boot files, operating system images, and applications to one or more of client electronic devices 610, 612, and 614. Client electronic devices 610, 612, and 614 may be referred to as “clients” with respect to a server such as server computer 604. In some examples, one or more of electronic devices 610, 612, and 614 may be stand-alone devices corresponding to data processing system 500. Network data processing system 600 may include more or fewer servers and clients, as well as other devices not shown.

Program code located in system 600 may be stored in or on a computer recordable storage medium and downloaded to a data processing system or other device for use. For example, program code may be stored on a computer recordable storage medium on server computer 604 and downloaded to client 610 over network 602 for use on client 610.

Network data processing system 600 may be implemented as one or more of a number of different types of networks. For example, system 600 may include an intranet, a local area network (LAN), a wide area network (WAN), or a personal area network (PAN). In some examples, network data processing system 600 includes the Internet, with network 602 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. Fig. Y is intended as an example, and not as an architectural limitation for any illustrative embodiments.

### Discussion

The example of the guidance content system described above provides a closed-loop system for the creation and distribution that may incorporate robust data collection, analysis and reporting, enabling collections of guidance content units, such as user Guides, to rapidly evolve to ever higher levels of effectiveness over a very short period of time. With use by a population with varying levels of prior knowledge, experience and expertise, electronic user guides, as envisioned in the claimed technology, can rapidly evolve to approach 6 sigma levels of effectiveness across a wide range of users.

User guides (owner manuals, operating instructions, process instructions, etc.) are useful to understanding and being able to more effectively use or apply a wide range of products, services, processes and procedures. Existing user guides are often a result of choosing a medium or media, creating the user guide and distributing same. Periodic reviews and user feedback (generally anecdotal in nature) are used to update user guides on either a scheduled or ad hoc basis. As such, they were not designed as an overall system of distribution, feedback, evolution and re-distribution. The processes and procedures that do exist to update user guides do not necessarily keep pace with changes in the products, services, processes and procedures they are intended to support.

The guidance content system may provide a closed-loop system for creating, distributing and rapidly evolving user guides.

### GLOSSARY OF TERMS

Scene—A basic building block of the guidance content system. An individual bit of information or instruction. It may consist, but is not limited to any of the following, alone or in various combinations of Media (Images, Video, Text, Animations, Forms, Quizzes, etc.), Narrative Text, and Audio (Speech, Sounds, Music).

Response—A selection made from a scene that may be associated with additional scenes to expand upon or clarify the original or base scene

User—Any person (customer, employee, supplier, vendor, etc.) employing a user guide.

Producer—A person or organization that develops, distributes and maintains (updates) a user guide

Expert—A person or group of that collectively have the most complete understanding of the product, service, process or procedure, are able to effectively communicate, and are the creators of a user guide.

The claimed technology consists of 4 subsystems integrated into a single closed-loop system.
User Guide Creator (Creator)
User Center (Distribution)
User Guide Database (Data Storage and Analysis)
User Guide Player (Player)

The User Guide Creator or development module application may allow a person working alone or persons working as a team to create electronic user guides. The user guide steps the user through a sequence of scenes. The scenes may be configured to allow the user, through the selection of responses or choices, to modify the sequence of scenes to receive information of a type and at the level of detail they may need or want to understand and successfully apply the information.

Several features/capabilities may be provided:

1. Scenes, responses and choices may all be modular. Each can be rapidly (in a matter of minutes) edited or replaced in whole or in part without affecting the integrity of a user guide.

2. New or additional scenes, responses or choices can be rapidly created and inserted into existing user guides with relative ease.

3. An option for a user to provide feedback may be made an integral part of any scene or response.

4. With use, user feedback can be generated and provided to experts for creating better user guides.

In context of an overall system, an aspect of the described user guide creator is an ability to systematically and rapidly make changes. Producers of user guides may make changes/updates to user guides in a matter of minutes to a few hours. This stands in stark contrast to videos or slide presentations (both automated and non-automated), websites and other, “legacy approaches”, that typically take much longer to update. As an aside, videos typically take 6 to 8 weeks to update, slide presentation instructions 2-4 weeks and websites weeks to months, because they are inherently linear presentations of information, and not modular. Thus, careful consideration must be given to any changes because of the probability of unintended consequences and the lengthy cycle time to identify and correct same. The user center may be a distribution and data hub. The user center may be the location where published user guides that have been released for distribution reside. User guides may be published to public space (public collection) or to one of any number of private spaces (private collections). The distribution of user guides published to private collections may be controlled by the publisher.

The user center also may serve as a coordination center to form and manage teams to create user guides and to coordinate the activities of team members. In a preferred embodiment, team members can be assigned specific roles within the creation, review, approval and publishing process. In a preferred embodiment, voice and/or text chat capabilities are provided for team coordination purposes.

The user guide database may provide standard functions generally associated with storing account information, user guides, media elements used in the user guides, etc. As it relates to the claimed technology, the database may provide two capabilities to the system. First, the database may collect and collate user feedback. Users may be able to note problems and provide feedback, such as at every scene in a user guide sequence. In this example, feedback is converted from what is generally an ancillary user activity to one that is integral and indexed to specific steps in the process.

Second, the database may collect and collate detailed audit trails of each usage of a user guide. Date/time stamps may be created at a beginning and end of each step accessed by a user. That data may be used to establish a time-sequenced audit trail of each use. Collated and summarized audit trail data may provide a statistical mapping of sequences through a user guide. In a preferred embodiment, data/time stamps mark the beginning and end of each step accessed by a user in a sequence. This may provide not only a statistical map of usage, but also a picture of where users are spending their time within a sequence of scenes, responses and choices. Together, these may provide insight into those portions of a user guide that are effective, those that users find problematic, and even those that could be simplified to reduce the time required without losing overall effectiveness. These capabilities change user guides from what is today largely based on surveys and anecdotes into a more evolved, closed loop improvement system based on statistics and comprehensive usage data.

The user guide player may transform flow of information from a presentation-based, sending (push) of information to a user-initiated, pulling of information. With legacy approaches, users are presented with information in sequence, with a type of media and at a level of specificity (detail) that the producer of the presentation (video or other) feels is appropriate. In such legacy approaches, a user is relegated to being a passive viewer of the information. In some cases legacy approaches have been augmented with various forms of supplementary info capabilities such as linked Q&A's, hotspot links to added information, videos within videos, etc. Lacking an underlying structure to make user navigation intuitive, these augmentations of legacy approaches are limited in scope in that a user merely selects and receives information in a linear fashion making it technically challenging to create efficient and effective presentations.

In the guidance content system described above, a user may be given a wide variety of information options at each step in a collection of guidance content units. These options can include presentation of the same information in different forms, where the same information at different levels of detail and mediums may be provided to a user automatically or upon request. As such, access to explanatory or supplemental information regarding the specifics contained in the information being presented is possible. A user may choose information they wish to receive in a way they wish to receive it. This changes a user's role from passive to active and from viewer to protagonist. Most importantly, it is a user who determines when they have a sufficient understanding of the information at any given point, to proceed to the next and then how they wish to proceed.

The user guide player or guidance content presentation module may be designed to enable a user to navigate what can be numerous possible sequences, without getting confused or lost. Associated with this is the concept that as a user accesses responses, a reference to a scene from which the user departed from may be retained. Thus, no matter how many levels of scenes and responses have been accessed, the path to return to the original point of departure is provided to the user.

As discussed above with respect to the User Guide Database, as a user accesses information each scene and response may be date/time stamped. In a preferred embodiment, the beginning and end of each scene and response accessed is date and/or time stamped. This provides an accurate audit trail. Alternatively, just a beginning (access) or end (departure) for each scene could be date and/or time stamped and an approximation of time spent derived through subtraction can be obtained by the system. This provides a very accurate accounting of what has transpired. To add context and clarification regarding reasons a user has choosing a particular path, the User Guide Player may offer an opportunity for each user to comment on any or all scenes. While commenting is voluntary, over time, many users and many uses of a user guide, context and clarification may be added to the audit trail data, thereby enabling the producers of the user guide to make targeted changes to the user guide.

The described technology may incorporates principles of a closed loop continuous improvement process with creation, distribution, use and evaluation of user guides. This approach may eliminate barriers that may otherwise obviate the ability of such a system to operate.

The described system may provide the conveying of information to a user of a product, service, process, or procedure via an electronic user guide. When a user lacks sufficient knowledge or expertise to successfully use a product or service, or to successfully complete a process or procedure, an effective method of assisting the user, while at the same time conveying an understanding of the same, so that the user can become more self-reliant, may be for a subject matter expert and skilled communicator (expert), acting a personal tutor, to guide the user step by step through to a successful outcome. In this process, the expert actively engages with and mentors the user by prompting the user to ask questions, and having the user answer the expert's questions. This may transform the communication from an expert-centered sending (one-way presentation) of information to a user-centered acquisition (two-way exchange) of information in a way and at the level of detail that both facilitates successful completion of the task the first time and increases the user's knowledge and expertise enabling the user to become more self-sufficient in the future.

In all but the most exceptional situations, providing an expert as a personal tutor who is available whenever and wherever needed by any and all users is impossible or impractical. User guides in various forms have been created in an effort to provide users with necessary information they need to successfully use products or services, or to successfully complete processes or procedures. Lacking a better platform, user guides have primarily been linear presentations from the expert's perspective, relegating the user to being a passive observer. Personal tutoring otherwise has been too difficult and costly to be of practical use.

The system may provide for creating electronic user guides that closely emulate the aforementioned user-centered acquisition of information through mentoring by an expert personal tutor.

A first scene may be a first bit of expert-provided information to start the aforementioned user-centered communication. When creating the first scene and every scene thereafter, the expert may be challenged to consider the information presented from the perspective of the overall user population and, based on their knowledge of and experience with users, to provide the users with responses and choices by which each user may then guide the sequence of information.

If a scene contains content (words, concepts, images, etc.) that some users may not understand, may need to have communicated in a different way, or that they may wish to explore in more detail before proceeding to the next scene, the expert may append responses to that scene. Responses appended to a scene may be accessed in any of a variety of ways. In a preferred embodiment, responses are accessed by swiping the associated scene up to reveal a first response that is below that scene, swiping up again reveals the second response, and so on. An alternative is to provide some form of menu with the associated scene to allow the user to access selectively the appended responses. For each response, scenes may be created to provide information in sequences to satisfy the user's need for additional information. As before, if the expert feels that the scene may contain content (words, concepts, images, etc.) that some users may not understand, may need to have communicated in a different way, or that they may wish to explore in more detail before proceeding to a next scene, the expert may append these to the scene as responses. This process of scenes being appended with responses that lead to further scenes that may be appended with responses is repeated as necessary until the communicator or expert, based on their knowledge of and experience with a target user population is satisfied that each user will be able to guide the communication onward with a sufficient understanding and ability to apply the information being conveyed. For example, an expert may provide guidance to a user in a way that allows a user to determine when the user is ready to choose a direction to proceed.

In some cases, when a user is ready to proceed, they simply move to the next scene. In a preferred embodiment this is accomplished by swiping from right to left to reveal the next scene. In some cases, the user may be presented choices or options. One type of choice is to select a path forward from among multiple paths. For example, a user may choose a model of a product a user has from among different models of the product via such provided options or choices. A second type of choice is to choose to proceed to a new section, skipping sections of information that may be redundant or undesirable to a user's understanding. In a preferred embodiment, choices are presented as a type of media in a scene.

In this way a logically complex, multi-dimensional array of scenes, responses and choices can be created and used with ease.

In a further example, the guidance content system may maintain a relationship between a scene from which a user departed (point of origin) and a sequence of responses and scenes that follow. The expert can create a myriad of response-to-scene-to-response sequences for the user. This differs greatly from current technologies that, in general, provide very limited question and response capabilities. As is the case in a one-on-one communication of information, once the user is satisfied that they sufficiently understand the information, or have satisfied their curiosity regarding related information and decide to proceed, the communication returns to a local point of origin and continues onward from such point. Swiping down to reveal the scene above returns a user to a proximate point of origin.

User guides can be created on a variety of devices including smart phones, tablets and computers and be used as mobile web applications or device-specific, “native” applications via those same devices. To create a user guide, an expert may start by constructing a scene. A representation of the structure of a scene may be presented to the expert via a user guide creation application. The expert may create a scene by inserting some or all of the possible scene components such as media, narrative text, or audio.

As has been mentioned, a detailed audit trail of scenes and responses accessed, time spent on each scene and response, choices made and answers to questions (quizzes) may be collected and automatically sent to a database. These audit trails can be used to document user understanding and agreement, for compliance purposes, and to obviate potential liability issues. Additionally, analysis of aggregate use data may provide experts with information regarding changes, additions or deletions that may be made to a user guide.

The described guidance content system may allow experts to create electronic user guides that closely emulate person-to-person interaction of an expert providing personalized assistance to a user. The application and value of such a method and system may not be limited to just user guides. Emulating person-to-person interaction has application in education, storytelling, and social media. The guidance content system, thus, may provide a new medium for creating and sharing a user-centered and guided/directed information flow to enable task success. In the same way that PowerPoint™ and Keynote™ applications reinvented overhead presentations, the guidance content system may be used to reinvent the mentor-to-apprentice approach to task success.

The guidance content system may be used to promote and seek to assure first time successful accomplishment of a task or objective. User-centered methodology may enable users with widely varying levels of prior knowledge and experience to be successful in completing a task a first time and every time. As such, the guidance content system may allow a user to complete tasks efficiently and effectively without requiring the user to be completely trained in knowledge required to complete the task without the proposed guidance content system. For example, the guidance content system may allow a user to complete a task of fixing a car engine via steps and guidance without the user having to be fully educated or trained in mechanics. Using the present guidance content system, the user fixing a car engine may be guided to task completion without any formal, traditional linear education, such as education provided by most colleges.

As such, the guidance content system may allow completion of tasks by means of providing the user with the ability to choose only as much information as the user requires to complete the task, without requiring the user to master general skills. This can be termed cognitive apprenticeship, where a mentor provides as much information as an apprentice needs to be successful. Over time, learning may occur, and the amount of required mentoring decreases, eventually resulting in the apprentice mastering the subject, skill or task.

Existing approaches teach users about a subject, task or skill in the hope that the user will be able to apply what is taught to a specific situation. However, the present guidance content system may configure guidance content to individually assist a user to be successful in completing a task. Knowledge or understanding may come as a byproduct of success, but is not a prerequisite. Structurally, an expert creating such aforementioned user guides may be able to construct a myriad of likely paths that different users may take to achieve task success in a way that does not force users to follow paths they do not need or cannot benefit from. Existing approaches do not have such ability.

Flexibility and adaptability of the present guidance content system may allow better and more efficient task accomplishment compared to one-size-fits-all instruction. For example, the guidance content system may allow a user to solve a Rubik's Cube more efficiently than a standard YouTube video about solving Rubik's Cubes. As such, a one-size-fits-all presentation or user guide would not achieve a same success rate as a path-selectable or path-navigable guide provided by the present guidance content system.

If a user desires to accomplish something with respect to a subject, task, skill, process or procedure, a first challenge for any medium is to determine the user's objective. The present guidance content system inherently has access to the user's objective by letting the user choose, from a set of options, a desired path in a collection of guidance content units. Legacy approaches merely provide an index or the like. Information that any particular user may need is based on their prior knowledge, prior experience and the context of their use. The present guidance content system may be used to compose guidance content that uses knowledge of the user's prior experience. Different people absorb information differently. Some people will resonate well with pictures, others with text and still others are audio learners. As such, users of collections of guidance content units appropriately composed using the present guidance content system may choose paths that work well for their learning styles, even if the users are not aware of such media distinctions. Social constructivists call this situational learning or contextual learning and it is one of the fundamental concepts in cognitive apprenticeship as described above.

An expert may provide a user with checkpoints where the user may confirm that they are ready to move on. Via queries, the guidance content system may learn that a user is not ready to move on. If the user does not understand the presented information, or the user guide does not deem the user ready to move on, it could be that the user needs to see a proper sequence demonstrated in a different media format, or a different storytelling style. For example, the user may need to see information sequences broken down into smaller increments with greater detail, it could be that there is an underlying concept they are missing and need remedial instruction on that point, or it could be that they need a combination of media constructs.

Existing legacy approaches commonly provide “initial training” to ultimately hope a user will complete a task or learn a subject. The claimed guidance content system may be used to start on the other end with “on-demand assistance.” Such “on-demand assistance” is described by Dr. Engyvig in “Full Spectrum Knowledge Sharing”. It is difficult or virtually impossible to take an approach geared toward initial training and have it be as effective as an appropriately composed collection of guidance content units created using the present guidance content system.

A collection of content units may thus be developed based on the collective knowledge and expertise of an organization's experts to identify assistance paths, levels, questions and answers, etc. The user may then dictate the direction, level of detail and medium of presentation that is appropriate for the assistance or information they desire. Other approaches attempt to tell the user what he or she needs to know to accomplish a task. A collection of content units developed as described allows the user to drive the conversation and obtain the information to be successful at every step within a task or other learning endeavor. This approach corresponds to what may be called cognitive apprenticeship. In such an approach, it may not simply be a case of understanding subject matter. It preferably is a process that allows the user to become proficient in the successful application of the subject matter. Heretofore, the application of the principles of cognitive apprenticeship have been confined to subject matter experts (people) applying those principles by working directly with apprentices (other people). A guidance content system as described provides features that allow a presentation to be developed and used that may emulate and thus replace the master in the cognitive apprenticeship, master-apprentice relationship.

### CONCLUSION

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only, and do not constitute a characterization of any claimed invention. The subject matter of the invention(s) includes all novel and nonobvious combinations and subcombinations of the various elements, features, functions, and/or properties disclosed herein. The following claims particularly point out certain combinations and subcombinations regarded as novel and nonobvious. Invention(s) embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the invention(s) of the present disclosure.

We claim:

1. A user-driven content-presenting apparatus comprising:
at least one output device, each output device being configured to output to a user content of a content unit in a form sensible to a user;
a storage device for storing a collection of interrelated content units, with each content unit having a sequence link to at least one other content unit, and a plurality of the content units in the collection of interrelated content units having sequence links to at least three other content units, at least one sequence link of at least one of the content units in the plurality of content units being a sequence link to a content unit that does not have a sequence link back to the at least one content unit;
at least one input device for receiving inputs from the user; and
a processor configured to output on the at least one output device content units sequentially in response to inputs received from the user on the at least one input device, to receive on the at least one input device an indication input by the user that correlates to a respective one of the sequence links with another content unit, including to receive on the at least one input device an indication input by the user that correlates to a sequence link to a content unit that does not have a sequence link back to the at least one content unit.
